(19) United States
(12) Patent Application Publication
(10) Pub. No.: US 2026/0113186 A1
(43) Pub. Date: Apr. 23, 2026

(54) System and Method for Immutable Governance-Based Conditional Data Release with Hardware-Isolated Key Operations

(71) Applicant: Rodney Edward Ast, White Rock (CA)

(72) Inventor: Rodney Edward Ast, White Rock (CA)

(21) Appl. No.: 19/288,999

(22) Filed: Aug. 2, 2025

Related U.S. Application Data
(63) Continuation-in-part of application No. 19/198,071, filed on May 4, 2025.
Application No. 19/198,071 is a continuation-in-part of application No. 18/920,860, filed on Oct. 19, 2024.

(51) Int. Cl. H04L 9/08; G06Q 30/018; H04L 9/32

(52) U.S. Cl. CPC H04L 9/0877; G06Q 30/018; H04L 9/3242

(57) ABSTRACT

A system for conditional data release features an Orchestration Engine (OE) that enforces Immutable Governance parameters, such as validation thresholds and time delays, which are sealed in tamper-evident Vault Metadata. The OE performs all policy validation, including invoking a Cryptographic Hash Verification Engine (CHVE) to confirm metadata integrity. Only after successful validation and satisfaction of all governance conditions does the OE route a Wrapped Data Encryption Key (DEK) to a separate, hardware-isolated Secure Execution Environment (SEE). During vault creation, payload data is sent directly to the SEE for encryption, ensuring the OE never accesses plaintext. The SEE performs key unwrapping and decryption exclusively within its secure boundary, never exposing the plaintext DEK to other components. This architectural separation of the OE's validation logic from the SEE's cryptographic execution provides a secure framework for conditional data release, preventing policy modification and ensuring plaintext keys remain isolated within a trusted hardware environment.

### CROSS-REFERENCE TO RELATED APPLICATIONS

This application is a Continuation-in-Part (CIP) of U.S. patent application Ser. No. 19/198,071, filed on May 4, 2025, which is itself a Continuation-in-Part of U.S. patent application Ser. No. 18/920,860, filed on Oct. 19, 2024. The disclosures of both prior applications are incorporated herein by reference in their entirety.

### FIELD OF THE INVENTION

The invention relates to hardware-secured cryptographic systems implementing immutable governance policies through architecturally separated validation and execution components. More specifically, the invention concerns systems and methods for encrypting, distributing, and conditionally releasing digital information wherein an Orchestration Engine (OE) performs all validation, policy enforcement, and governance decisions before invoking ephemeral Secure Execution Environments (SEEs) exclusively for hardware-isolated cryptographic key operations and Encrypted Data Vault (EDV) unwrapping.

### BACKGROUND OF THE INVENTION

Current computer security systems implementing role-based access control exhibit a fundamental architectural vulnerability wherein access policies, temporal constraints, and governance parameters exist as mutable software objects accessible to privileged accounts or compromised administrative systems. This mutable policy architecture creates critical attack vectors including: (i) unauthorized modification of time-delay parameters to bypass temporal security controls; (ii) alteration of multi-party authentication thresholds to reduce consensus requirements; (iii) modification of validation criteria to enable unauthorized access; and (iv) disabling of governance enforcement mechanisms to circumvent immutable policy requirements.

Furthermore, these conventional systems are highly vulnerable to collusion. When a sufficient number of designated agents, trustees, or administrators conspire, they can pool their credentials to meet multi-party consensus requirements and bypass the intended security measures, often without any delay that would allow for detection. There is a need for an architecture that can withstand such collusion attacks, not just by logging them, but by rendering them ineffective through inherent design.

Existing solutions attempt to address these vulnerabilities through software-based audit trails, blockchain logging, or cryptographic sealing mechanisms. However, these approaches fundamentally rely on mutable enforcement mechanisms that can be circumvented by sufficiently privileged actors or compromised system administrators.

Furthermore, conventional systems lack architectural separation between policy validation logic and cryptographic execution environments, creating systemic vulnerabilities where compromise of policy enforcement components can defeat cryptographic isolation mechanisms.

Conventional access control systems typically store governance policies, time-delay parameters, and validation thresholds in software-accessible memory locations where administrators or compromised privileged accounts can modify security parameters after initial vault creation. This mutable architecture creates several critical technical problems: scenarios of policy tampering where actors with elevated privileges can retroactively weaken security parameters; temporal security degradation where time-locked mechanisms can be bypassed through policy modification rather than waiting for release conditions; and multi-vector compromise scenarios where an unauthorized party need only compromise admin credentials rather than satisfy the original multi-party consensus requirements.

Current systems that attempt to provide conditional data release capabilities generally intermingle policy enforcement mechanisms directly within cryptographic execution environments, creating performance bottlenecks and expanded attack surfaces where administrative accounts can modify access parameters after initial system configuration. These systems exhibit the fundamental flaw of mutable policy layers that permit unauthorized post-creation modifications, creating attack vectors through privileged user access to governance parameters.

There exists a need in the art for a system and method that achieves policy immutability through architectural design rather than software protection mechanisms, while maintaining operational efficiency through separation of validation logic and cryptographic execution environments.

Moreover, existing systems that implement Secure Execution Environments (SEEs) operate these components as isolated processing units rather than architecturally interdependent orchestration engines. Without the unified integration of secure processing boundaries with distributed coordination mechanisms, these systems cannot achieve the modular deployment across diverse operating environments required for diverse conditional release scenarios while maintaining consistent security properties through defense-in-depth architecture that eliminates single points of failure.

What is needed is an immutable governance architecture that performs comprehensive policy validation before invoking hardware-isolated cryptographic operations, thereby preventing unauthorized policy modification while maintaining efficient system performance through architectural separation of validation and execution phases.

The technical problem addressed is therefore not merely one of enforcing business rules, but one of fundamental computer architecture. Conventional systems treat policy enforcement as a software application layer running on a general-purpose machine. This creates an inherent vulnerability, as any software layer can be modified or bypassed by a sufficiently privileged process or user. The present invention departs from this paradigm by proposing a new, specific-purpose computer architecture wherein policy validation and cryptographic execution are not just logically separated but are rendered Architecturally Interdependent. This interdependence, enforced by a mandatory, sequential handshake between distinct hardware-enforced components, represents a specific technical solution that improves the functioning of the computer itself by creating a trust model that is resilient to privileged user compromise, a failure mode inherent in prior art architectures.

Conventional architectures also suffer from a catastrophic failure mode: once root-level credentials for user accounts, administrator accounts, Secure Execution Environments, or external Key Management Services are stolen, every protected data set can be decrypted if the ciphertext is centrally stored. The present inventors recognized that this single-vector collapse is unacceptable for high-value assets. Accordingly, the invention introduces an Event Vault Architecture (EVA) in which each Encrypted Data Vault (EDV) is distributed only to the Creator and a quorum of File Storage Agents (FSAs). Unless an unauthorized party can acquire that specific EDV copy in addition to compromising all credentials, plaintext remains inaccessible.

### SUMMARY OF THE INVENTION

The Event Vault Architecture (EVA) implements Share-Now-Reveal-Later Workflows (SNRLs) through five Architecturally Interdependent components with strict operational separation: (1) Orchestration Engine (OE) containing integrated Cryptographic Hash Verification Engine (CHVE), Key Release Time Delay (KRTD), and Machine-Enforced Governance (MEG) subsystems that perform all validation and policy enforcement; and (2) ephemeral Secure Execution Environments (SEEs) instantiated exclusively for hardware-isolated cryptographic operations after OE validation completion.

The Event Vault Architecture (EVA) provides a technical improvement in computer-security architecture by solving the fundamental mutable policy vulnerability through architectural separation of validation logic and cryptographic execution. Unlike conventional systems that permit post-creation policy modifications, the present invention enforces governance immutability by sealing access parameters at Encrypted Data Vault (EDV) creation and verifying them through the Cryptographic Hash Validation Engine (CHVE) before any hardware-isolated decryption occurs. This ensures that unauthorized policy changes render the EDV undecryptable, thereby providing a secure-by-design enforcement mechanism rather than merely applying administrative controls.

The Event Vault Architecture (EVA) creates an Encrypted Data Vault (EDV) for any digital payload and seals four policy pillars at vault creation: (i) Governance Mode (GM), (ii) Role-Based Access Control (RBAC), (iii) Event Validation (EV) threshold, and (iv) a Key Release Time Delay (KRTD). All parameters are stored in tamper-evident Vault Metadata, with the Cryptographic Hash Validation Engine (CHVE) computing and validating integrity hashes before any cryptographic operations proceed to the Secure Execution Environment (SEE).

A Wrapped Data Encryption Key (Wrapped DEK) is generated and stored separately from the ciphertext, enabling the Event Vault Architecture (EVA)'s Zero-Knowledge Router Architecture (ZKRA) to orchestrate encrypted data and key flows without revealing plaintext. When the Event Validation (EV) threshold is satisfied, the Encrypted Data Vault (EDV) transitions to an Unlocked state and the Key Release Time Delay (KRTD) isolation period commences. During the KRTD, the governing party may invoke the CHVE on the EVA to authenticate Vault Metadata integrity and, upon successful verification, submit a DEK-unwrap request to the Secure Execution Environment (SEE). The non-governing party may not invoke the Cryptographic Hash Validation Engine (CHVE) or request Wrapped DEK unwrapping until the KRTD has fully elapsed or immediately if the KRTD equals zero. Both parties may continue to perform CHVE-to-SEE decryption operations until the Wrapped DEK is destroyed or the EDV returns to the Locked state.

This unified architecture enables modular deployment across diverse operating environments while maintaining uniform security guarantees through interdependent processing workflows that provide defense-in-depth protection with no single point of failure. The Orchestration Engine (OE) integrates multiple access control frameworks including Role-Based Access Control (RBAC), Policy-Based Access Control (PBAC), Attribute-Based Access Control (ABAC), and Condition-Based Access Control (CBAC) within the same architectural framework.

Collectively, the Event Vault Architecture (EVA) components enable Share-Now-Reveal-Later Workflows (SNRLs), in which data is cryptographically sealed at creation and only conditionally released to authorized Agents upon satisfaction of predefined event or governance conditions. Creator-only fallback recovery paths Timed Locked Recovery Window (TLRW) and Emergency Vault Recovery (Self-EVR) provide deterministic access without compromising the EVA's zero-knowledge posture.

As a result of this interdependent design, the Event Vault Architecture (EVA) preserves ciphertext confidentiality even under a condition of total platform compromise. This resilience is achieved because a successful breach is predicated on two additional, independent compromises external to the EVA platform itself. First, an attacker must gain complete control over the external notification accounts (e.g., email) of all required members. This external compromise is a prerequisite as it is the only method to both suppress real-time alerts of unauthorized activity and enable an account password change, thereby locking the legitimate owners out and preventing countermeasures such as Open Vault Request (OVR) cancellation by a notified Validation Agent (VA) or the Vault Lock Reset (VLR) by EDV Creator. Second, the attacker must locate and acquire physical possession of the specific, distributed Encrypted Data Vault (EDV) file. Only after these external systems are defeated can the final cryptographic workflow be attempted, which is itself protected by the Orchestration Engine's integrity checks and the file-level Attempt Attestation Wrapper (AAW). Consequently, at most one vault can be exposed; a compromise does not generalize to other EDVs.

### DETAILED DESCRIPTION

### Terminology

### System Architecture & Components

Architecturally Interdependent: The design principle whereby the Orchestration Engine (OE) and the Secure Execution Environment (SEE) are technically coupled such that the SEE is inoperable without receiving a valid, cryptographically signed command from the OE, and the OE will not issue said command until all Immutable Governance policies have been validated. This mutual dependency ensures that a compromise of one component cannot defeat the overall security model.

Cryptographic Hash Verification Engine (CHVE): A subsystem that performs cryptographic integrity checks on Vault Metadata to detect tampering before the Wrapped Data Encryption Key (Wrapped DEK) is released or any processing occurs in the Secure Execution Environment (SEE), operating as an integral component of the unified Orchestration Engine (OE).

EVA Compromise Resilience (ECR): A security property of the Event Vault Architecture (EVA) in which ciphertext remains inaccessible even under a total compromise of all platform credentials and infrastructure components. This resilience is predicated on the separate requirement to possess the distributed Encrypted Data Vault (EDV) file and to control the external notification channels of all required members to neutralize operational defenses.

Event Vault Architecture (EVA): The overall hardware-secured cryptographic framework comprising an Orchestration Engine (OE) with integrated validation subsystems and ephemeral Secure Execution Environments (SEEs) exclusively for cryptographic operations.

Immutable Governance: A state of resistance to modification enforced by a specific technical mechanism, not by administrative privilege. Within the Event Vault Architecture (EVA), governance parameters are rendered immutable by computing a cryptographic hash of the entire Vault Metadata structure at the time of Encrypted Data Vault (EDV) creation and sealing said hash within the metadata itself. The Orchestration Engine (OE) is architecturally configured to re-compute this hash and verify it against the sealed hash as a mandatory pre-condition for any cryptographic operation. A hash mismatch, indicating any post-creation alteration, causes the OE to terminate the process, thereby rendering the EDV permanently inaccessible under the altered policy.

Machine-Enforced Governance (MEG): The access-control layer created by the immutable pillars of Governance Mode (GM), Event Validation (EV), Key Release Time Delay (KRTD), and a Secure Execution Environment (SEE) to enforce policy through automation within the architecturally integrated Orchestration Engine (OE), preventing human override of sealed parameters.

Orchestration Engine (OE): The architecturally integrated combination of Secure Execution Environment (SEE) processing and distributed coordination mechanisms that operate as inseparable components, enabling modular deployment across diverse operating environments across diverse use cases while maintaining consistent security properties through defense-in-depth architecture with no single point of failure. In various embodiments, the OE may be implemented as a dedicated secure co-processor, a trusted process running on a CPU with hardware-enforced memory isolation, or a hardened virtual machine with a dedicated hardware root of trust.

Secure Execution Environment (SEE): A hardware-isolated enclave, such as an AWS Nitro Enclave or Intel SGX instance, that is instantiated on-demand by the Orchestration Engine (OE) for the sole purpose of performing a single, specific cryptographic operation. The SEE is ephemeral in that it is created with no persistent state, executes only the minimal code required for key unwrapping and decryption, and is architecturally configured to be terminated immediately upon returning the decrypted payload or a failure attestation to the OE. This lifecycle instantiate, execute, terminate, ensures the plaintext Data Encryption Key (DEK) exists only for microseconds within a hardware-isolated boundary and is never exposed to the host operating system or any persistent storage.

Unilateral Decryption Prevention: A core security principle of the architecture, enforced by the mandatory, sequential handshake between the Orchestration Engine (OE) and the Secure Execution Environment (SEE). The OE is configured to refuse to issue a decryption command until all Immutable Governance policies are validated, and the SEE is configured to refuse to perform cryptographic operations without a valid command from the OE, thereby ensuring no single component or compromised account can unilaterally access plaintext.

Zero-Knowledge Router Architecture (ZKRA): A logical architecture implemented by the Orchestration Engine (OE) that acts as a state machine and message broker for all components in the system. It is defined as “zero-knowledge” because it is architecturally prevented from ever accessing plaintext data or unwrapped cryptographic keys. Its implementation consists of a set of defined software routines within the OE that: (i) receive and validate signed requests (e.g., Open Vault Requests) from Agents; (ii) maintain the state of each Encrypted Data Vault (EDV) (e.g., Locked, Unlocked); (iii) route the Wrapped Data Encryption Key (Wrapped DEK) and Secure Execution Environment (SEE) attestation documents to the external Key Management System (KMS); and (iv) route the encrypted EDV file to the SEE for decryption. The ZKRA's core security guarantee comes from the fact that it only ever handles opaque, encrypted blobs of data and keys, maintaining the confidentiality of the payload from the platform operator and the OE's own host environment.

### Governance & Policy

Agent Governance: A Governance Mode (GM) in which control over Encrypted Data Vault (EDV) access, Wrapped Data Encryption Key (Wrapped DEK) release, and recovery lies exclusively with the designated Agents, enforced through Architecturally Interdependent Secure Execution Environment (SEE) processing and distributed coordination.

Creator Governance: A Governance Mode (GM) in which the Creator retains elevated privileges such as Vault Lock Reset (VLR) and optional recovery paths, enforced through Architecturally Interdependent Secure Execution Environment (SEE) processing and distributed coordination.

Governance Mode (GM): An immutable operational model selected at vault creation. Two modes are supported: Creator Governance and Agent Governance. The chosen mode is recorded at creation time via a one-time configuration known as the Governance Switch (GS), which is cryptographically bound into the Vault Metadata within hardware-isolated boundaries. The selected Governance Mode (GM) determines the distribution of access rights, recovery privileges, and Event Validation (EV) logic for the Encrypted Data Vault (EDV) and cannot be altered post-creation.

Vault Metadata: A cryptographically bound, tamper-evident data structure that stores and enforces governance configurations, Agent roles, access policies, and timing rules for an Encrypted Data Vault (EDV). It is retained in a read-only state for auditability even after the Data Encryption Key (DEY) is deleted and is processed exclusively within the Orchestration Engine (OEs) hardware-isolated boundaries.

### Access Control & Roles

Access Policy Model (APM): The logical framework used by the system to determine whether access to a Wrapped Data Encryption Key (Wrapped DEK) shall be granted. Supported models include Role-Based Access Control (RBAC), Policy-Based Access Control (PBAC), Attribute-Based Access Control (ABAC), and Condition-Based Access Control (CBAC). These models are cryptographically enforced and are immutable after Encrypted Data Vault (EDV) creation within the architecturally integrated Orchestration Engine (OE).

Agent: Any human or non-human participant assigned to an Encrypted Data Vault (EDV) role. Roles include Validation Agent (VA), File Storage Agent (FSA), and Key Access Agent (KAA), all managed through the unified Orchestration Engine (OE) framework.

Attribute-Based Access Control (ABAC): A rule-based access control model where permissions are evaluated dynamically based on attributes of users, devices, or environmental conditions. It enables complex access policies, often without direct human validation, integrated within the unified Orchestration Engine (OE) framework.

Condition-Based Access Control (CBAC): An access-policy model that grants or denies requests by evaluating Boolean conditions derived from sealed environmental or third-party data, such as application programming interface feeds or oracle signals, processed through the architecturally integrated Orchestration Engine (OE).

Creator: Any human or non-human entity such as a user account, automated software agent, or micro-service, that (i) initiates Encrypted Data Vault (EDV) creation and (ii) designates the full set of initial Orchestration Engine (OE) parameters, including Governance Mode (GM), role assignments, Event Validation (VA) threshold, Key-Release Time Delay (KRTD), and any other policy or configuration settings required before EDV finalization.

Event Validation (EV): The condition that is met when the number of valid Open Vault Requests (OVRs) from distinct, authorized Validation Agents (VAs) reaches a predefined numerical threshold. This threshold, referred to as the event validation threshold, is sealed within the immutable Vault Metadata at the time of creation and is enforced by the Orchestration Engine (OE).

File Storage Agent (FSA): An Agent responsible for preserving an Encrypted Data Vault (EDV) file as part of the distributed storage model that eliminates single points of failure.

Key Access Agent (KAA): An Agent entitled to receive and use a Wrapped Data Encryption Key (Wrapped DEK) after the Encrypted Data Vault (EDV) is unlocked through the Orchestration Engine's (OEs) coordinated validation workflows.

Policy-Based Access Control (PBAC): A rule-based model that enforces Encrypted Data Vault (EDV)-specific behavior based on predefined governance policies, such as Event Validation (EV) thresholds, timing conditions, and recovery eligibility, integrated within the unified Orchestration Engine (OE) framework.

Role-Based Access Control (RBAC): A security framework that governs access permissions based on predefined user roles, such as Validation Agent (VA), Key Access Agent (KAA), or File Storage Agent (FSA), enforced through the Architecturally Interdependent Orchestration Engine (OE) framework.

Validation Agent (VA): A designated Agent role responsible for validating if predefined conditions have been met and initiating Open Vault Requests (OVRs) to form a consensus through the Orchestration Engine's (OEs) distributed coordination mechanisms.

### Vault States & Workflows

Decrypt-Save-Auto Re-Lock (DSAVR): The default post-decryption workflow that re-locks the Encrypted Data Vault (EDV) for future access through the unified Orchestration Engine (OE).

Decrypt-Save-Disassemble (DSD): An alternate workflow that destroys the Wrapped Data Encryption Key (Wrapped DEK) after use, rendering the Encrypted Data Vault (EDV) permanently undecryptable.

Encrypted Data Vault (EDV): A container consisting of encrypted payload data with an attached Attempt Attestation Wrapper (AAW), distributed to File Storage Agents (FSA) for preservation. The Vault Metadata and Wrapped Data Encryption Key (Wrapped DEK) are maintained separately within the architecturally integrated Orchestration Engine (OE) to prevent single points of compromise.

Emergency Vault Recovery (Self-EVR): An optional, Creator-initiated recovery mechanism in Creator Governance Mode (GM) that allows for a one-time, time-limited emergency unlock by providing the Encrypted Data Vault (EDV) file and a pre-configured passphrase.

Open Vault Request (OVR): A request submitted by a Creator or Validation Agent (VA) to unlock an Encrypted Data Vault (EDV). Only requests from VAs count toward Event Validation (EV) through the coordinated validation workflows of the Orchestration Engine (OE).

Relock Grace Interval (RGI): A fixed window after decryption during which additional Key Access Agents may decrypt before the Encrypted Data Vault (EDV) auto-locks through the Orchestration Engine's (OEs) coordination mechanisms.

Timed-Locked Recovery Window (TLRW): A Creator-only recovery window aligned to an epoch that permits a one-time, passphrase-gated decryption through the Orchestration Engine's (OEs) coordinated recovery workflows.

Trigger Event (TE): A condition, occurrence, or reason specified by the Creator at Encrypted Data Vault (EDV) creation that, when satisfied, prompts Validation Agents (VAs) to submit Open Vault Requests (OVRs).

Vault Lock Reset (VLR): A command available exclusively to the Creator when the Encrypted Data Vault (EDV) is under Creator Governance mode. The VLR cancels all active Open Vault Requests (OVRs) and returns the EDV to the Locked state.

Vault State Locked: The state of an Encrypted Data Vault (EDV) when its Data Encryption Key (DEK) is wrapped, withheld, or otherwise inaccessible under the governing policies enforced by the Orchestration Engine (OE).

Vault State Unlocked: The state of an Encrypted Data Vault (EDV) when its Wrapped Data Encryption Key (Wrapped DEK) is made available for unwrapping after all access conditions have been met through the Orchestration Engine's (OEs) coordinated validation workflows.

### Key Management & Cryptography

Attempt Attestation Wrapper (AAW): A security mechanism that irreversibly disables access to an Encrypted Data Vault (EDV) after a fixed number of failed decryption attempts. The failure threshold (N) is set by the Event Vault Architecture (EVA) at the platform level and is not configurable by the Creator. Once the threshold is exceeded, the AAW destroys the Wrapped Data Encryption Key (Wrapped DEK), rendering the vault permanently unreadable, even if the correct decryption key is later presented.

Customer Master Key (CMK): A persistent cryptographic key managed by a third-party Key Management Service (KMS) used to encrypt and decrypt Data Encryption Keys (DEKs). The Customer Master Key (CMK) is never exposed to the system or the Secure Execution Environment (SEE).

Data Encryption Key (DEK): The symmetric key that encrypts the payload, stored only in wrapped form outside the Secure Execution Environment (SEE) and managed exclusively through the architecturally integrated Orchestration Engine's (OE).

Extensible Framework Cryptographic Wrapping (EFCW): A process where each Wrapped Data Encryption Key (Wrapped DEK) is encrypted with a Federal Information Processing Standard 203-compliant Key-Encapsulation Mechanism and stored as a sealed blob in Vault Metadata within the Secure Execution Environment (SEE) boundaries.

Key Management Service (KMS): An external service or hardware security module that wraps and unwraps Data Encryption Keys (DEKs) under a Customer Master Key (CMK), integrated with the Orchestration Engine (OE) through secure interfaces.

Key Release Time Delay (KRTD): A configurable delay that must elapse after Event Validation (EV) before the Wrapped Data Encryption Key (Wrapped DEK) becomes available. The Key Release Time Delay (KRTD) value may be increased but never reduced below the set point at Encrypted Data Vault (EDV) creation that is sealed through the Immutable Governance parameters.

Wrapped Data Encryption Key (Wrapped DEK): A Data Encryption Key (DEK) that has been encrypted by a separate, higher-order key, such as a Customer Master Key (CMK) managed by an external Key Management Service (KMS). The wrapping methodology involves the Orchestration Engine (OE) sending the plaintext DEK (which exists only ephemerally within an SEE during vault creation) to the KMS, which then encrypts it with the CMK and returns the resulting ciphertext, or “wrapped key,” to the OE. This wrapped key is stored as an opaque blob in Vault Metadata. The corresponding unwrap operation can only be performed by the KMS and is gated by policies requiring a valid attestation document from a legitimate SEE, ensuring the plaintext DEK is only ever revealed directly to a trusted, hardware-isolated environment.

### Utility Features/Extensions

Audit Trail: An append-only, cryptographically signed record of significant Encrypted Data Vault (EDV) actions maintained across all Orchestration Engine (OE) components. The Audit Trail serves as the basis for a notification system configured to dispatch alerts to Creator and Agents associated with an EDV upon the occurrence of said significant actions.

Scheduled Release Mechanism (SRM): A mechanism elected by a sender for an encrypted email attachment that sets a future, immutable date and time for the release of the Wrapped Data Encryption Key (Wrapped DEK) through the unified Orchestration Engine's (OEs) time-based coordination.

Share-Now-Reveal-Later Workflow (SNRL): A conditional data-release process in which data is cryptographically protected upon creation and only becomes decryptable by authorized parties upon satisfaction of preconfigured event or policy conditions.

### Description of the Invention

### Architectural Overview: Validation-execution Separation

The Event Vault Architecture (EVA) implements Immutable Governance through architectural separation of validation and cryptographic execution phases:
Phase 1—Pre-Validation (Orchestration Engine Domain): The Orchestration Engine (OE) performs comprehensive validation before any secure enclave instantiation. The Cryptographic Hash Verification Engine (CHVE) validates policy integrity and authorization conditions within the OE framework. Key Release Time Delay (KRTD) enforces temporal constraints and time-lock compliance through OE validation logic. Machine-Enforced Governance (MEG) verifies immutable policy compliance, with governance policies cryptographically bound to initial creation parameters such that modification attempts result in validation failure preventing Secure Execution Environment (SEE) invocation.
Phase 2—Cryptographic Execution (SEE Domain): Ephemeral secure enclaves are instantiated exclusively after complete OE validation passes. Hardware-isolated key derivation and Encrypted Data Vault (EDV) unwrapping operations occur within tamper-resistant boundaries. No policy logic, validation, or governance decisions occur within SEE boundary. Secure enclave terminates immediately after cryptographic operations complete.

### Orchestration Engine (OE) Component Integration

The Orchestration Engine (OE) integrates validation subsystems through immutable policy binding. Cryptographic Hash Verification Engine (CHVE) integration operates within OE using cryptographically sealed policy templates that cannot be modified post-creation without detection. Key Release Time Delay (KRTD) integration enforces temporal constraints through OE validation logic that checks current system time against immutable release schedules before authorizing Secure Execution Environment (SEE) instantiation. Machine-Enforced Governance (MEG) integration maintains governance policies cryptographically bound to initial creation parameters, with any modification attempts resulting in validation failure that prevents SEE invocation.

### Hardware Isolation Model

Secure Execution Environment (SEE) instances provide hardware-enforced isolation boundaries specifically for cryptographic operations. Secure enclaves utilize hardware attestation to verify execution integrity. Key material handling occurs exclusively within tamper-resistant hardware boundaries. Encrypted Data Vault (EDV) unwrapping operations are isolated from host system software access. Ephemeral design ensures no persistent state within secure enclaves, with architectural separation preventing complex validation logic from expanding the attack surface of hardware-isolated environments while ensuring cryptographic operations occur only after comprehensive policy compliance verification.

All unwrapping operations are executed within the Secure Execution Environment (SEE) through the architecturally integrated processing workflows, and the decrypted payload is returned only to authorized parties through hardware-attested verification mechanisms that cannot operate independently of the distributed coordination components.

### Cryptographic Framework and Post-Quantum Readiness

The Event Vault Architecture (EVA) supports Extensible Framework Cryptographic Wrapping (EFCW) where each Wrapped Data Encryption Key (Wrapped DEK) is encrypted using Advanced Encryption Standard with elliptic curve keys and then further wrapped using a post-quantum cryptographic algorithm such as Module-Lattice-based Key-Encapsulation Mechanism in accordance with National Institute of Standards and Technology Federal Information Processing Standard 203. The Vault Metadata records all supported algorithms within hardware-isolated boundaries, allowing for multi-mode backward compatibility while maintaining the unified Orchestration Engine (OE) architecture.

### Access Control Framework Integration

The Orchestration Engine (OE) integrates multiple Access Policy Models (APMs) within a single architectural framework. Role-Based Access Control (RBAC) governs Agent role assignments and permissions. Policy-Based Access Control (PBAC) enforces Encrypted Data Vault (EDV)-specific behavior based on predefined governance policies. Attribute-Based Access Control (ABAC) enables dynamic permission evaluation using user, device, or environmental attributes. Condition-Based Access Control (CBAC) processes Boolean conditions derived from sealed environmental or third-party data sources.

All access control decisions flow through the OE under Machine-Enforced Governance (MEG) and are subject to hardware-isolated verification by the Cryptographic Hash Verification Engine (CHVE) before any key operation. MEG ensures the immutable application of sealed policy parameters whether RBAC, PBAC, ABAC, or CBAC through cryptographic and logical constraints that cannot be altered post-creation.

### Vault Creation Workflow

Upon Encrypted Data Vault (EDV) creation, a Creator submits a Create EDV request to the Orchestration Engine (OE), including Governance Mode (GM) selection, Role-Based Access Control (RBAC) Agent selections, Event Validation (EV) thresholds, Key Release Time Delay (KRTD), and optional defined fallback recovery settings (e.g., TLRW, Self-EVR), and directs the payload data to be sent by the Creator directly to a Secure Execution Environment (SEE) for encryption. The OE invokes the Secure Execution Environment (SEE) to generate a Data Encryption Key (DEK), encrypt the payload, and wrap the DEK. In other embodiments, the SEE attaches an Attempt Attestation Wrapper (AAW) to the EDV for tamper-evident protection. The OE then serializes Vault Metadata containing all governance parameters and invokes the Cryptographic Hash Verification Engine (CHVE) to compute and embed an integrity hash before returning the EDV ciphertext bundle.

Next, the OE stores the Vault Metadata on the Event Vault Architecture (EVA) in encrypted-at-rest storage, replicates the Encrypted Data Vault (EDV) ciphertext bundle to the Creator and to each File Storage Agent (FSA), and issues registration invitations to all designated Agents. The OE enforces RBAC to ensure only Agents may register and participate. The EDV remains in an Inoperable state under the OEs coordination until every Agent completes registration. Upon registration, the OE verifies each Agent's identity and role, and confirms the selected GM, ensuring that subsequent event-driven workflows adhere to the Immutable Governance policy sealed at creation. The creation of the EDV and the assignment of all Agent roles are recorded as significant events in the Audit Trail, triggering an initial notification to all designated EDV members.

### Event Validation Processing

In response to a Trigger Event (TE), designated Validation Agents (VAs) log into the Event Vault Architecture (EVA) and submit Open Vault Requests (OVRs) to the Orchestration Engine (OE). The OE enforces Role-Based Access Control (RBAC) to ensure only VAs may issue OVRs. Each OVR submission is recorded in the Audit Trail, triggering a notification to all members associated with the Encrypted Data Vault (EDV). A VA may also cancel an OVR they have previously submitted, which removes its contribution to the Event Validation (EV) threshold; this cancellation is also recorded in the Audit Trail and triggers a notification to all members. Once the accumulated OVRs meet the EV threshold and subject to the selected Governance Mode (GM), the OE transitions the EDV to the Unlocked state and initiates the Key Release Time Delay (KRTD).

During KRTD, the governing party may submit a decryption request; such requests invoke the Cryptographic Hash Verification Engine (CHVE) to recompute and verify metadata integrity before passing the Wrapped Data Encryption Key (Wrapped DEK) to the Secure Execution Environment (SEE) for unwrapping and EDV decryption. After each decryption operation, control returns to the OE to enforce Decrypt-Save-Auto Re-Lock (DSAVR) or Decrypt-Save-Disassemble (DSD) policies. Upon KRTD expiration, non-governing party may also likewise submit decryption requests, which follow the same CHVE to SEE to OE workflow.

### Key Release and Hardware Isolation

During the Key Release Time Delay (KRTD) isolation period under Creator Governance, only the Creator may submit a decryption request to the Orchestration Engine (OE). Such requests invoke the Cryptographic Hash Verification Engine (CHVE) to validate Vault Metadata integrity before routing the Wrapped Data Encryption Key (Wrapped DEK) into the Secure Execution Environment (SEE) for unwrapping and Encrypted Data Vault (EDV) decryption. Following each decryption, the OE enforces Decrypt-Save-Auto Vault Re-Lock (DSAVR) or Decrypt-Save-Disassemble (DSD) policies. At any time while the EDV remains in the Unlocked state, the Creator, if under Creator Governance mode, may invoke Vault Lock Reset (VLR) via the OE to cancel outstanding Open Vault Request (OVR) progress. The invocation of a VLR is recorded as a significant event in the Audit Trail, triggering a notification to all members associated with the EDV.

Once the KRTD has fully elapsed or immediately if KRTD is set to zero, the Creator and all designated Key Access Agents (KAAs) may equally submit decryption requests. Each request follows the CHVE to SEE to OE workflow: CHVE re-verifies metadata integrity, SEE unwraps the Wrapped DEK and decrypts the EDV, and the OE applies any post-SEE policies. Each such decryption request is recorded as a significant event in the Audit Trail, triggering a notification to all members associated with the EDV. Machine-Enforced Governance (MEG) ensures that these timing and role-based access rights are enforced immutably and that no party can alter the sealed governance parameters post-creation.

Under Agent Governance or after expiration of the KRTD under Creator Governance, both the Creator and all designated KAAs may submit decryption requests by invoking the CHVE to validate Vault Metadata integrity, followed by SEE unwrapping of the Wrapped DEK and EDV decryption. Each such decryption request is recorded as a significant event in the Audit Trail, triggering a notification to all members associated with the EDV. MEG ensures that these role-and timing-based access rights are enforced immutably, and that all DEK unwrap and EDV decryption operations occur solely within the SEE under the OE's interdependent processing logic.

### Post-Decryption Handling

Successful decryption triggers the Decrypt-Save-Auto Vault Re-Lock (DSAVR) workflow through the Orchestration Engine's (OEs) coordination mechanisms. Alternatively, if the Decrypt-Save-Disassemble (DSD) workflow is invoked, the permanent destruction of the Wrapped Data Encryption Key (Wrapped DEK) is recorded as a significant event in the Audit Trail, triggering a final notification to all members associated with the Encrypted Data Vault (EDV). Upon completion of the decryption, the Orchestration Engine (OE) coordinates the post-decryption workflow. The OE instructs the SEE to perform the final action on the Data Encryption Key (DEK) as dictated by the DSAVR or DSD workflows (i.e., re-wrap or delete). The SEE executes this command, generates a signed cryptographic attestation of the outcome, and securely returns it to the OE. The OE then validates this attestation, writes the signed record to the Audit Trail, and sets the vault state back to Locked through the Zero-Knowledge Router Architecture (ZKRA). A Relock Grace Interval (RGI) may be configured to permit additional Key Access Agents (KAAs) to decrypt before the EDV returns to Locked state through the unified coordination framework.

In other embodiments under Creator Governance, two optional, immutable fallback recovery mechanisms are provided as Creator-controlled features: Timed-Locked Recovery Window (TLRW), which opens a time-bounded pre-expiration access window, and Emergency Vault Recovery (Self-EVR), which grants emergency access upon Creator authentication via login; both of which require (i) proof of EDV file possession and (ii) correct passphrase entry. Both TLRW and Self-EVR are permanently disabled upon destruction of the Wrapped DEK under the Machine-Enforced Governance (MEG) logic.

### Attempt Attestation Wrapper (AAW) Mechanism

In one embodiment, the Attempt Attestation Wrapper (AAW) functions as a cryptographic “fuse” integrated with the Encrypted Data Vault (EDV) file. The AAW maintains an encrypted counter, attempt count, initialized to zero. During each decryption attempt that proceeds to the final cryptographic workflow, the SEE is instructed to first decrypt attempt count, increment its value, and verify that it is less than a predetermined maximum threshold, maximum attempts. If the count is less than the threshold, the SEE re-encrypts the new count and proceeds with the EDV decryption. If the count is greater than or equal to the threshold, the SEE is instructed to refuse decryption and may, in some embodiments, cryptographically corrupt the EDV file, thereby rendering it permanently unreadable. This mechanism ensures that the failure limit is enforced at the file level.

### Security Analysis Through Defense-in-Depth Architecture

The architecture preserves a full zero-knowledge posture through the Zero-Knowledge Router Architecture (ZKRA) that brokers all data, key, and coordination signals without exposing plaintext to application layers. Ciphertext is stored only with File Storage Agents (FSAs) through the distributed storage model, while Wrapped Data Encryption Keys (Wrapped DEKs) remain isolated within the Secure Execution Environment (SEE) and external Key Management Service (KMS) through hardware-attested boundaries.

The EVA Compromise Resilience (ECR) property is predicated on a multi-domain security model that requires a successful breach to occur across multiple, independent domains. A successful breach of an Encrypted Data Vault (EDV) is conditioned upon two prerequisite compromises: (i) complete control over the external email accounts of all required EDV members, and (ii) physical possession of the specific, distributed EDV file.

The first condition is necessary to neutralize the system's primary operational defense: a real-time notification and response loop. The submission of an Open Vault Request (OVR), a required step to satisfy the Event Validation (EV) threshold, is an action that triggers immediate notifications to all members. Control of a member's external email account is a prerequisite for a successful breach, as it is the only method to both suppress these notifications and initiate a password change to lock the legitimate owner out of their EVA account. Without control of the external email account, a notified legitimate owner retains the ability to access their account and invoke countermeasures, such as OVR cancellation by a Validation Agent (VA) or a Vault Lock Reset (VLR) by the Creator.

Should this operational layer be defeated, the attacker must still overcome the second prerequisite: locating and acquiring the EDV file, which is physically distributed to the Creator and File Storage Agents (FSAs) and is not stored centrally.

Only after satisfying both of these prerequisite conditions can the final cryptographic workflow even be attempted. This final stage is itself protected by the Orchestration Engine's Cryptographic Hash Verification Engine (CHVE) integrity check and the file-level Attempt Attestation Wrapper (AAW), which renders the EDV permanently unreadable upon execution failure. The necessity of compromising these independent operational, physical, and cryptographic layers constitutes the ECR guarantee, ensuring that at most one EDV may be exposed under a total compromise scenario and that the breach does not generalize to other EDVs.

The compound defense-in-depth architecture creates emergent security properties through the Architecturally Interdependent of the OE. No single point of compromise can provide complete access to EDV contents. Multiple independent security layers including cryptographic isolation within hardware boundaries, distributed data storage eliminating central points of compromise, multi-agent validation preventing unilateral access, Immutable Governance sealed at creation, and tamper-evident file protection through AAWs must be simultaneously compromised for system failure.

Hardware-enforced immutability prevents policy manipulation even by privileged administrators through Machine-Enforced Governance (MEG). Cryptographic isolation ensures sensitive operations never occur outside trusted boundaries through the SEE integration. The distributed trust model prevents unilateral access while maintaining operational flexibility through the coordinated validation workflows of the OE.

Accordingly, the OE and SEE operate in a mutually interdependent handshake, each refusing to proceed without cryptographic artefacts produced by the other, thereby eliminating any unilateral path to plaintext.

### Error Handling and Failure Conditions

The architecture is configured to handle specific failure conditions to maintain system integrity. These conditions are managed by the Orchestration Engine (OE) according to the Immutable Governance policies.

Failure During Vault Setup: If any designated Agent fails to complete the initial registration process, the EDV is maintained in an Inoperable state. While in this state, all EDV actions by both the Creator and other Agents are disabled by the OE, with the potential exception of EDV deletion, the availability of which is dependent on the sealed Governance Mode. The EDV remains Inoperable until all designated Agents have successfully completed registration.

Failures During Decryption Workflow: Several conditions can occur during an active attempt to decrypt an EDV. If a Vault Lock Reset (VLR) is issued by the Creator (under Creator Governance) before the KRTD has expired, all active OVRs are immediately invalidated, and the EDV reverts to the Locked state. Similarly, if the Self-Emergency Vault Recovery (Self-EVR) mechanism is invoked with an incorrect passphrase, the OE denies the decryption request and logs the failed attempt in the Audit Trail.

In various embodiments, the system and method described herein may be implemented as executable instructions stored on a non-transitory computer-readable medium, such that when executed by one or more processors, the instructions cause the system to perform conditional release of encrypted data in accordance with Immutable Governance policies. These instructions manage an Encrypted Data Vault (EDV) and corresponding Vault Metadata sealed with a cryptographic integrity hash at creation time, including Governance Mode (GM), Event Validation (EV) thresholds, Key Release Time Delay (KRTD), and Access Policy Model (APM) selections such as RBAC, PBAC, ABAC, or CBAC. The system evaluates Open Vault Requests (OVRs) submitted by Validation Agents (VAs) and enforces the KRTD following satisfaction of the EV threshold. Integrity of Immutable Governance parameters is verified by the Cryptographic Hash Verification Engine (CHVE) before any Wrapped Data Encryption Key (Wrapped DEK) is routed to a hardware-isolated Secure Execution Environment (SEE), which decrypts the EDV exclusively within its trusted boundary. The plaintext Data Encryption Key (DEK) is confined to the SEE and never exposed to other components, thereby improving the functioning of the computer by preventing plaintext key exposure and eliminating post-creation policy tampering through cryptographic and architectural enforcement.

In certain embodiments, the system further includes an Attempt Attestation Wrapper (AAW) configured to render the EDV permanently undecryptable after a predetermined number of failed decryption attempts. The Orchestration Engine (OE) and SEE operate in an Architecturally Interdependent configuration, wherein the SEE is inoperable unless a valid command is issued from the OE after all Immutable Governance conditions have been validated. In some use cases, the EDV may protect structured database records, with CRUD permissions encoded into the Vault Metadata and released only upon satisfaction of predefined conditions. The Zero-Knowledge Router Architecture (ZKRA) routes encrypted keys and data without accessing plaintext. Validation Agents may include both human and non-human actors such as APIs or smart contracts. The system is resilient to root-level credential compromise, as possession of Vault Metadata and Wrapped DEK alone is insufficient to decrypt the EDV in absence of CHVE validation and SEE-based key handling.

### Illustrative Working Example: End-to-End Release Workflow

The following example illustrates the interdependent operation of the system.

Request Initiation: A registered Validation Agent (VA) submits an Open Vault Request (OVR) to the Orchestration Engine (OE) to satisfy a Trigger Event (TE). This action is recorded in the Audit Trail and triggers a notification to all members associated with the Encrypted Data Vault (EDV).

OE Pre-Validation: The OE receives the OVR. It first verifies that the number of OVRs meets the immutable Event Validation (EV) threshold stored in the Vault Metadata. Upon meeting the threshold, the OE's internal state machine transitions the Encrypted Data Vault (EDV) to Unlocked state and initiates the Key Release Time Delay (KRTD) timer, also defined in the Vault Metadata.

Integrity Verification: After the KRTD elapses, a Key Access Agent (KAA) submits a decryption request. This request is recorded as a significant event in the Audit Trail, triggering a notification to all members associated with the EDV. The OE then invokes its internal Cryptographic Hash Verification Engine (CHVE) to re-calculate the cryptographic hash of the current Vault Metadata and compares it to the hash stored at the time of creation. If the hashes match, integrity is confirmed. If they do not, the process is terminated.

SEE Instantiation and Attestation: With all governance conditions met and integrity verified, the OE prepares to invoke the SEE. The OE first makes a request to the underlying hypervisor (e.g., the AWS Nitro Hypervisor) to allocate resources and launch a new, isolated virtual machine instance from a pre-signed enclave image. Upon successful instantiation, the SEE generates a cryptographic nonce and includes it in an attestation document. This document, which is signed by the hypervisor using a private key whose public key is available for verification, contains a set of Platform Configuration Register (PCR) hashes (e.g., PCR0 for the enclave image hash, PCR1 for the kernel, PCR2 for the application code) and the nonce. The SEE returns this signed attestation document to the OE. The OE verifies the hypervisor's signature and confirms the PCR hashes match the expected values for a valid, untampered SEE instance.

Key Unwrapping: The OE sends the Wrapped Data Encryption Key (Wrapped DEK) and the attestation document to an external AWS Key Management Service (KMS). The KMS key policy is configured to only allow the unwrap operation if the PCR values in the attestation document match the expected values for a valid SEE. Upon successful validation by KMS, the unwrapped DEK is sent directly to the SEE over a secure channel.

Decryption and Termination: The SEE, now possessing the plaintext DEK, decrypts the EDV payload. The plaintext data is returned to the authorized KAA. Immediately following this operation, the SEE is terminated, destroying the plaintext DEK and leaving no residual state.

### EXAMPLES

### Example 1: Secure Execution Environment Implementation

In one embodiment, the Secure Execution Environment (SEE) may be implemented using AWS Nitro Enclaves, which provide hardware-isolated compute environments within Amazon EC2 instances. The Nitro Enclave creates a separate, isolated compute environment with its own kernel, CPU, and memory, ensuring that even privileged users or code running on the parent EC2 instance cannot access the enclave's memory or CPU.

### Example 2: Post-Quantum Cryptographic Implementation

In another embodiment, the cryptographic operations may utilize FIPS-203 post-quantum key encapsulation mechanisms to ensure long-term security against quantum computing threats. The system may implement lattice-based cryptographic schemes such as CRYSTALS-Kyber for key establishment while maintaining compatibility with existing infrastructure.

### Example 3: Hardware Attestation Implementation

The hardware attestation process may be implemented using Intel SGX attestation mechanisms or ARM TrustZone technology, providing cryptographic proof of the secure execution environment's integrity and ensuring that only authorized code executes within the isolated environment.

### Alternative Embodiments and Use Cases

In other embodiments, the Event Vault Architecture (EVA) includes a Timed-Locked Recovery Window (TLRW) that provides the Creator with a fallback access method prior to a predetermined epoch through the coordinated recovery workflows. TLRW must be configured at Encrypted Data Vault (EDV) creation and is only available in Creator Governance through the sealed governance parameters. If enabled, the EVA opens a one-time access window at a configured time interval before the target epoch through the Machine-Enforced Governance (MEG) system.

During this window, the Creator may submit the Encrypted Data Vault (EDV) file and a configured passphrase to retrieve the Wrapped Data Encryption Key (Wrapped DEK) through the hardware-isolated processing boundaries. If the Wrapped DEK has already been disassembled, TLRW is permanently disabled through the Immutable Governance enforcement. This mechanism replaces fragile human executor processes and ensures deterministic access under pre-approved parameters through the Architecturally Interdependent OE.

In other embodiments, Validation Agent (VA) and Key Access Agent (KAA) roles may be assigned to non-human actors, such as application programming interfaces, smart contracts, oracles, or automated agents through the unified coordination framework. These entities may submit authenticated Open Vault Requests (OVRs) and satisfy Event Validation (EV) threshold requirements through cryptographic proof processed within the Orchestration Engine's (OEs) hardware-isolated boundaries.

The selected Governance Mode (GM) continues to govern timing, validation thresholds, and override behavior through the MEG system. This allows the Event Vault Architecture (EVA) to be used in automated access governance scenarios, including secure cloud service delegation, artificial intelligence-mediated policy enforcement, and distributed systems requiring quorum-based key release through the architecturally integrated framework.

In other embodiments, the Event Vault Architecture (EVA) supports encrypted email attachments with Scheduled Release Mechanism (SRM) processed through the unified OE. A registered user uploads one or more attachments and specifies a future Scheduled Release Time through the coordinated time-based mechanisms. The attachments are encrypted within the Secure Execution Environment (SEE) using the same hybrid cryptographic model applied to EDVs through the Architecturally Interdependent processing workflows.

Vault Metadata is sealed at upload within hardware-isolated boundaries, and recipients must register with the EVA before decryption through the unified coordination framework. The Wrapped Data Encryption Key (Wrapped DEK) becomes accessible only after the Scheduled Release Time through the MEG system. If the sender deletes the message prior to release, decryption is permanently disabled through the immutable enforcement mechanisms.

These encrypted attachments inherit all EDV protections, including Extensible Framework Cryptographic Wrapping (EFCW), Attempt Attestation Wrapper (AAW) enforcement, and tamper-evident auditability through the comprehensive defense-in-depth architecture of the OE.

In another embodiment, the Event Vault Architecture (EVA) may be applied as a secure, governance-enforced access broker for structured database resources. The system may govern Create, Read, Update, and Delete (CRUD) operations on sensitive datasets by requiring Validation Agents (VAs), including human and non-human entities, to satisfy the predefined Event Validation (EV) threshold before data access or mutation is permitted. The DEK used to decrypt or enable access to the database record may be managed through the same cryptographically enforced workflow as standard Encrypted Data Vault (EDV)s, with the Vault Metadata encoding the specific CRUD permissions, access role assignments, and Key Access Agents (KAAs) entitled to act upon successful validation. This allows for secure delegation of CRUD actions, whether to internal employees, contractors, or AI agents under strict governance parameters enforced through the Architecturally Interdependent OE and Secure Execution Environment (SEE) components, ensuring conditional, event-driven release of structured data and full auditability of all access attempts.

### ADVANTAGES OVER PRIOR ART

Existing systems that implement Secure Execution Environments (SEE) operate these components as isolated processing units rather than Architecturally Interdependent orchestration engines. Without the unified integration of secure processing boundaries with distributed coordination mechanisms, these systems cannot achieve the modular deployment across diverse operating environments flexibility required for diverse conditional release scenarios while maintaining consistent security properties through defense-in-depth architecture that eliminates single points of failure.

Conventional access-control frameworks in computer security systems suffer from vulnerabilities due to mutable policy layers that permit unauthorized post-creation modifications. These systems typically allow administrators or privileged users to modify access policies, time-delay settings, and validation thresholds after initial configuration, creating significant security risks.

Existing key-splitting or key-shard custodianship schemes typically reassemble plaintext keys outside trusted execution environments, exposing critical attack surfaces during key reconstruction operations.

Current key management systems that utilize secure enclaves typically perform both policy validation and cryptographic operations within the same hardware-isolated boundary, resulting in complex policy engines running within resource-constrained secure environments and creating unnecessary exposure of validation logic to hardware-based attacks.

Conventional systems that attempt to provide conditional data release capabilities generally intermingle policy enforcement mechanisms directly within cryptographic execution environments, creating performance bottlenecks and expanded attack surfaces where administrative accounts can modify access parameters after initial system configuration.

The Event Vault Architecture differs from these conventional approaches through architectural separation of validation and execution phases, immutable policy enforcement through cryptographic binding, and ephemeral secure enclave design that limits hardware isolation to cryptographic operations exclusively.

The Event Vault Architecture is further distinguished from conventional secret-sharing and multi-signature wallet schemes. While such schemes use multi-party consensus, they typically allow for the modification of governance policies after creation and perform key reconstruction in general-purpose software environments. The EVA, by contrast, cryptographically freezes the governance policy in immutable metadata and strictly separates the policy validation (OE) from the hardware-isolated key handling (SEE), preventing both policy tampering and key exposure during reconstruction.

Similarly, the architecture improves upon standard time-locked encryption services. Prior art in this area often relies on mutable software timers that can be altered by a privileged attacker. The EVA's Key Release Time Delay (KRTD) is not a mutable timer but an immutable parameter sealed within the Vault Metadata. Its integrity is cryptographically verified by the CHVE as a mandatory pre-condition to any decryption attempt, making the KRTD architecturally non-bypassable.

The invention also represents a specific and non-obvious application of Trusted Execution Environments (TEEs) like AWS Nitro Enclaves. The novelty lies not merely in using an enclave for cryptographic operations, but in the specific control flow where the enclave is architecturally forbidden from instantiating until the external Orchestration Engine has completed its full, multi-step validation of the Immutable Governance policy. This pre-validation control flow is a key point of departure from standard TEE implementations.

Finally, the EVA provides a significant improvement over traditional Role-Based Access Control (RBAC) platforms. In conventional systems, roles and permissions can be altered by a system administrator. Within the EVA, roles are cryptographically frozen into the Vault Metadata at the time of creation. Consequently, a compromise of administrative or even root-level credentials does not permit the alteration of these roles, as any such modification would invalidate the metadata's cryptographic hash, an event that would be detected by the Cryptographic Hash Verification Engine (CHVE), rendering decryption impossible.

What is claimed is:

1. A method for Immutable Governance-based conditional data release, the method comprising:
a) receiving, at a hardware-based Orchestration Engine (OE), a data-release request associated with an Encrypted Data Vault (EDV);
b) validating, by the OE, governance policy compliance through an integrated Cryptographic Hash Verification Engine (CHVE) that confirms the integrity of Immutable Governance parameters, said parameters being sealed at a time of creation of the EDV within Vault Metadata to form Immutable Governance metadata (IGM);
c) enforcing, by the OE, temporal constraints through an integrated Key Release Time Delay (KRTD) component, wherein the KRTD value is sealed within the Immutable Governance metadata;
d) verifying, by the OE, immutable policy compliance through an integrated Machine-Enforced Governance (MEG) component;
e) instantiating, by the OE upon successful validation, in a hardware-isolated secure enclave, an ephemeral Secure Execution Environment (SEE) that is Architecturally Interdependent with the OE and configured to be inoperable until the OE provides a valid cryptographic command;
f) performing, exclusively within the SEE, hardware-isolated key derivation and encrypted data vault unwrapping; and
g) terminating the SEE upon completion of cryptographic operations; wherein an architectural separation of the OE and SEE cryptographically prevent runtime modification of the IGM.

2. The method of claim 1, wherein the validation of the governance policy compliance by the CHVE comprises:
re-computing a cryptographic hash of the IGM at a time of the data-release request; comparing the re-computed hash to a pre-existing hash that was computed and sealed at the time of creation of the EDV; and,
confirming the integrity of the Immutable Governance metadata only if the re-computed hash and the pre-existing hash match.

3. The method of claim 1, wherein the Immutable Governance parameters further comprise a Governance Mode (GM) selected from a group consisting of Creator Governance and Agent Governance, wherein the GM is sealed in the Vault Metadata at creation and enforced by the OE.

4. The method of claim 1, wherein the SEE is configured to perform key unwrapping operations only in response to a command received directly from the OE after the OE has confirmed satisfaction of all Immutable Governance parameters.

5. The method of claim 1, further comprising attaching, by the OE, an Attempt Attestation Wrapper (AAW) to the EDV, wherein the AAW is a cryptographic container configured to render the EDV permanently unreadable by destroying its corresponding Wrapped Data Encryption Key after a predetermined number of failed decryption attempts.

6. The method of claim 1, wherein the OE integrates a plurality of Access Policy Models selected from a group consisting of Role-Based Access Control (RBAC), Policy-Based Access Control (PBAC), Attribute-Based Access Control (ABAC), and Condition-Based Access Control (CBAC), and wherein a selected model is enforced by the OE according to the Immutable Governance parameters.

7. The method of claim 1, wherein the Wrapped Data Encryption Key (DEK) associated with the EDV is encrypted using a post-quantum cryptographic algorithm compliant with Federal Information Processing Standard 203, providing Extensible Framework Cryptographic Wrapping (EFCW).

8. The method of claim 2, further comprising executing, by the OE, a Vault Lock Reset (VLR) command, wherein the VLR command invalidates all active Open Vault Requests (OVRs) and is available only when the GM is Creator Governance.

9. A system for Immutable Governance-based conditional data release, the system comprising:
a) a memory storing an Encrypted Data Vault (EDV) and a separate corresponding Vault Metadata structure containing Immutable Governance parameters;
b) a hardware-isolated secure enclave configured to host an ephemeral SEE; and
c) one or more processors configured to execute a hardware-based Orchestration Engine (OE) that is Architecturally Interdependent with the SEE, the OE being configured to:
i. process requests to access the EDV based on the Immutable Governance parameters, said parameters including an Event Validation (EV) threshold and a Key Release Time Delay (KRTD);
ii. invoke a Cryptographic Hash Verification Engine (CHVE) to verify integrity of the Vault Metadata; and
iii. send a command including a Wrapped DEK to the SEE only after determining that the EV threshold and the KRTD have been satisfied and that the CHVE has successfully verified the integrity of the Vault Metadata;
wherein the SEE is configured to, upon receiving the command from the OE, unwrap the Wrapped DEK and use it to decrypt the EDV exclusively within its hardware-isolated boundary.

10. The system of claim 9, wherein the OE and the SEE operate as part of a Zero-Knowledge Router Architecture (ZKRA) that brokers encrypted data, wrapped keys, and validation signals between system components without exposing a plaintext DEK to any component other than the SEE.

11. The system of claim 9, wherein the EDV is a structured database record, and wherein the Immutable Governance parameters further comprise permissions for Create, Read, Update, and Delete (CRUD) operations, such that the OE validates an EV threshold before instructing the SEE to provide a key that enables a permitted CRUD operation on the database record.

12. The system of claim 9, wherein the Immutable Governance parameters are enforced by MEG, a logical access-control layer implemented by the OE that prevents any post-creation modification of sealed governance parameters.

13. The system of claim 9, wherein the system is configured such that the EDV remains non-decryptable upon a compromise of all user accounts, administrator accounts, any SEE instance, and any external Key Management System (KMS) credential, in the absence of possession of a corresponding EDV file; and wherein an Attempt Attestation Wrapper is configured to render the EDV permanently unreadable after a predetermined number of failed decryption attempts.

14. The system of claim 9, wherein Validation Agents are non-human actors selected from a group consisting of application programming interfaces, smart contracts, and automated agents, and wherein the OE is configured to process Open Vault Requests (OVRs) from the non-human actors via cryptographic proof.

15. A non-transitory computer-readable medium storing instructions that, when executed by one or more processors, cause the performance of a method for conditional release of encrypted data, the method comprising:
a) managing, via a hardware-based Orchestration Engine (OE), an Encrypted Data Vault (EDV) and a separate, corresponding Vault Metadata structure containing Immutable Governance parameters sealed with a cryptographic integrity hash, said parameters including an Event Validation (EV) threshold and a Key Release Time Delay (KRTD);
b) determining, via the OE, that a number of received Open Vault Requests (OVRs) satisfies the EV threshold;
c) enforcing, via the OE, the KRTD, after satisfaction of the EV threshold;
d) invoking, by the OE, after the expiration of the KRTD, a Cryptographic Hash Verification Engine (CHVE) to confirm the integrity of the Vault Metadata by validating the cryptographic integrity hash;
e) routing, upon successful integrity confirmation, a Wrapped Data Encryption Key (DEK) from the OE to a hardware-isolated secure enclave hosting an ephemeral SEE; and
f) instructing the SEE to unwrap the DEK and decrypt the EDV, wherein a plaintext version of the DEK is confined exclusively to the SEE, thereby improving the functioning of the computer by preventing plaintext key exposure to the host operating system.
